(19) United States
(12) Patent Application Publication
(10) Pub. No.: US 2008/0235521 A1
(43) Pub. Date: Sep. 25, 2008

(54) METHOD AND ENCRYPTION TOOL FOR SECURING ELECTRONIC DATA STORAGE DEVICES

(75) Inventors: Clement Gosselin, Piedmont (CA); Ann Marie Colizza, Piedmont (CA); Luc Provencher, St-Lin-Laurentides (CA); Olivier Fournier, Blainville (CA)

Correspondence Address: BERESKIN AND PARR, 40 KING STREET WEST, BOX 401, TORONTO, ON, M5H 3Y2, CA

(73) Assignee: LES TECHNOLOGIES DELTACRYPT, Piedmont, QC (CA)

(21) Appl. No.: 11/688,403

(22) Filed: Mar. 20, 2007

(51) Int. Cl. G06F 12/14

(52) U.S. Cl. 713/193

(57) ABSTRACT

The present invention relates to a method and an encryption tool for securing electronic data storage devices. The method and encryption tool of the present invention install a file system on the electronic data storage device. Then, an input module of the encryption tool receives a user password. A key cryptography unit generates, from the user password, at least one key. A storage module stores the at least one key on the electronic data storage device. All data that is to be stored on the electronic data storage devices is encrypted using one of the at least one key. In accordance with some embodiments of the invention, the electronic data storage device is further filled with insignificant data.

### FIELD OF THE INVENTION

The present invention relates to electronic data storage devices, and more particularly to a method and an encryption tool for securing electronic data storage devices.

### BACKGROUND OF THE INVENTION

Nowadays, computer security has become an important issue. As computers are used to run daily operations, store business and personal confidential information, communicate with others, security has become mandatory to reduce and hopefully avoid industrial piracy and identify thefts.

Many security tools have been developed to increase protection of information stored on computers. For example, firewalls are used to block entrance of threatening mails and attachments, and to prevent intrusion of pirates on computers and on local area networks. Encryption algorithm applications are installed to encrypt hard drives and files contained on a computer and a server.

Some security tools specialize in encrypting content of electronic data storage devices, such as USB memory sticks, cameras, DVD readers/writers, and many other products, which offer additional mass storage external to a computer. Typically, these security tools consist of software that must be installed on the computer in which the electronic data storage device is to be inserted in. The installed security tool encrypts directly from the computer the information to be stored on the electronic data storage device, and stores it on the electronic data storage device. To access the information on the electronic data storage device, the latter must then be introduced in a computer that has the security tool installed thereon so as to allow proper decryption of the stored information thereon.

Some other security tools consist of software installed on an electronic data storage device to protect mobile data combined to software installed on the host computer in order for an electronic data storage device protection to function when connected to a computer with limited privileges (user account). Without the proper software on the host computer, the protected electronic data storage device will not function in most industries where computers have no administrator privileges in order to limit viruses' invasions.

Furthermore, some electronic data storage device security tool offer a secured partition and an unsecured partition leaving it up to the user to put his/her sensitive files in the right partition on his/her device.

There are multiple drawbacks with such security tools. When the security tool is installed on the computer, a user must first ensure that the security tool used to encrypt information on the electronic data storage device is installed on all computers from which he/she desires to access the encrypted information. To complicate matters, security tools are not compatible with one another, thus when the user wishes to use the electronic data storage device to share information with other people, he/she must ensure that the security tool that was used to encrypt the information on the electronic data storage device is available and installed on the computer of the people with whom he/she wishes to share the stored information.

Another drawback with prior art solutions is related to the fact that users of computers in many industries are not given administrator privileges. Although the grant of administrator privileges to all users is a risk that companies prefer not taking to maintain integrity of their networks, the absence of such rights prevents users from installing and using applications for securing the various data storage devices used. Thus, such applications can only be installed by the network administrators, while the various data storage devices can be plugged into the computer for information transfer with the computer, without adequate security.

And finally, most electronic data storage device security tools come with a secured and an unsecured partition. The responsibility of securing sensitive data relies on the user's decision. Corporate files may be misplaced in the unsecured section of the protected electronic data storage device or the user may judge that a file is not sensitive while an organization may think otherwise. Not only protection relies on a user's action but it also relies on his judgment.

To overcome these problems, users typically do not encrypt information stored on electronic data storage devices. Leaving such stored information unprotected causes a serious threat to the security of the stored information.

There is therefore a need to provide a security tool that is more practical for the encryption of information stored on electronic data storage devices. It could also be advantageous to provide a security tool that could be used on any computers with or without administrator privileges. It would also be a further advantage to provide a security tool that allows securing of sensitive files on electronic data storage devices without relying on any users' decisions.

### SUMMARY OF THE INVENTION

In order to overcome the problems encountered in the prior art, the present invention describes a method and an encryption tool for securing electronic data storage devices that is practical and simple. In accordance with some aspect of the invention, the method and encryption tool of the present invention can be used on an electronic data storage device when connected to a computer with or without administrator privileges. In accordance with another aspect of the invention, the method and encryption tool of the present invention allows securing of sensitive files on electronic data storage devices without relying on any users' decisions.

In a first aspect, the present invention relates to a method of securing an electronic data storage device. The method includes steps of creating a file system on the electronic data storage device, and requesting a user password. The method further includes a step of generating at least one key from the user password using key cryptography, and storing the at least one key on the electronic data storage device.

In another aspect, the present invention relates to an encryption tool for securing an electronic data storage device. The encryption tool includes a file system adapted for installing on the electronic data storage device, and an input module adapted for receiving a user password. The encryption tool further includes a key cryptography unit adapted for generating at least one key from a received user password. Furthermore, the encryption tool also includes a storage module adapted for storing the at least one key on the electronic data storage device.

### BRIEF DESCRIPTION OF THE DRAWINGS

The present invention will be more easily understood with reference to the following Figures, in which like references denote like parts/steps. The following Figures will further be used in connection with the Detailed Description of the Invention to describe aspects of the present invention, in which:

FIG. 1 is a detailed flowchart of a method for securing information on an electronic data storage device in accordance with an aspect of the present invention;

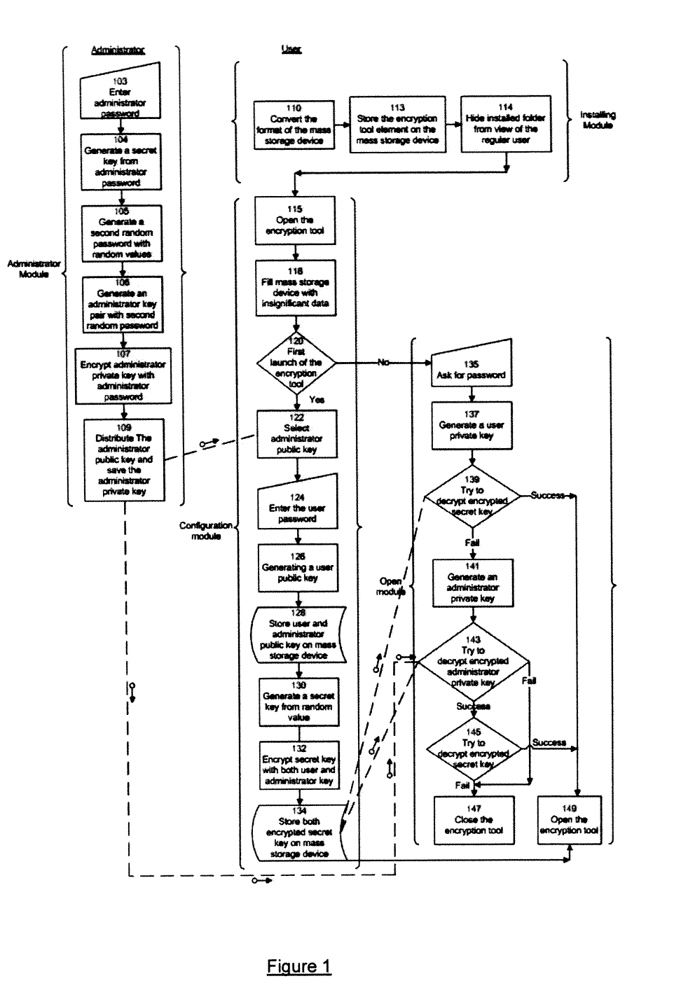

FIG. 2 is a flowchart of a method for handling information when using the method for securing information on an electronic data storage device of the present invention;

FIG. 3 is a detailed block diagram of the encryption tool in accordance with an embodiment of the present invention;

FIG. 4 is a detailed block diagram of the encryption tool of the present invention in accordance with an aspect of user configuring;

FIG. 5 is a detailed block diagram of the encryption tool of the present invention in accordance with an administrator configuring aspect;

FIG. 6 is a detailed block diagram of the encryption tool of the present invention in accordance with a user opening aspect;

FIG. 7 is a detailed block diagram of the encryption tool of the present invention in accordance with an opening administrator aspect;

FIG. 8 is a detailed block diagram of the encryption tool of the present invention in accordance with an encrypting information aspect;

FIG. 9 is a detailed block diagram of the encryption tool of the present invention in accordance with an information decryption aspect;

FIG. 10 is a detailed block diagram of the encryption tool of the present invention in accordance with a file execution aspect; and

FIG. 11 is a detailed block diagram of the encryption tool of the present invention in accordance with a file deletion aspect.

### DETAILED DESCRIPTION OF THE INVENTION

The present invention provides a simple and practical method and encryption tool for securing information stored on an electronic data storage device.

The expression “electronic data storage device” is used throughout the present specification and appended claims to refer to any type of electronic data storage device, which can be connected to a computer. Some examples of electronic data storage devices include a Compact Disk Writer, a Universal Serial Bus (USB) key, a camera, a Digital Versatile Disc (DVD) writer, an IPod™ an external hard drive, a Firewire™, a swappable hard disk, or any external memory means. Furthermore, the expression “information” and “file” are used interchangeably throughout the specification. The expressions “information” and “file” are intended to refer to any type of data that can be stored on an electronic data storage device.

In the context of the present invention, the expression “computer” includes any type of computer to which the electronic data storage device may be connected to: personal computer, laptop, Mac™, etc. Furthermore, the expression “creating a file system” is meant to include full or partial creation of a file system, as well as using of a library or copying of a file system, and all other forms of bringing into existence a file system. It should also be noted that the expression “file system” is not meant to refer only to Windows™ well-known file system, but is meant to refer to any set of data types for storage, hierarchical organization, manipulation, navigation, access and retrieval of data.

Furthermore, the expression “key cryptography” is used to relate to any type of cryptography that relies on the principle of generation and use of keys, and more particularly to asymmetric cryptography and symmetric cryptography. As to the expressions “asymmetric cryptography” and “symmetric cryptography”, their use is intended to incorporate all algorithms which generate respectively asymmetric keys and symmetric keys.

Referring to Error! Reference source not found.1 and Error! Reference source not found.2, there are shown detailed flowcharts of a method 100 for securing information on an electronic data storage device in accordance with an aspect of the present invention. The method can be subdivided in four parts: an installing part corresponding to steps 103-114, a configuring part including steps 115-134, an opening part depicted in steps 135-149, and finally a using part including steps 150-196. Although all parts can be used sequentially, it is also possible for certain aspects of the method of the present invention to only perform some of those parts, without departing from the scope of the present invention.

To be able to function from any computer with or without administrator privileges, the method of the present invention preferably does not install any module on a hosting computer. It also does not write any data on the hosting computer and it does not use any operating system Application Programming Interface (API) that requires administrator rights. This preferred methodology allows use of the method and the encryption tool of the present invention for electronic data storage devices connected to a hosting computer with limited privileges (user account), or use of a secured electronic data storage devices in accordance with the present invention on any computer without prior installing of a module or a special application to function.

The installing part starts with a step 103, for entering an administrator password. The method continues as per step 104, where a secret key is generated from the administrator password using a symmetric key generator. At the same time, a random value is generated at step 105. At step 106, from this random value is created an administrator public-private key pair, by use of an asymmetric key generator.

At step 107, the private key from the private-public key pair is encrypted using the secret key generated from the administrator password. A symmetric encryption algorithm is used to encrypt the private key. Step 109 further continues by saving the encrypted private key on the administrator's computer. This private key may include a MAC (Message Authentification Code) like HMAC to ensure its integrity protection and for authentication purposes.

An asymmetric encryption algorithm, such as the Rivest, Shamir, and Adelman (RSA) public-key encryption algorithm is preferably used to generate the administrator public-private key pair. This administrator public key, once created, is hashed with a hashing algorithm such as SHA-1, SHA-256 or MD5. The administrator public key hash digest is encrypted using the private key from the private-public key pair. The encrypted hash digest is saved at the end of the public key file, which is distributed at step 109 to the user before installing the encryption tool on his electronic data storage device. The hashing function is used to ensure that the public key file integrity has not been compromised.

The integrity verification is accomplished by comparing two hash digests when the administrator public key is used to open the encryption tool. The first hash digest comes from the encrypted administrator public key hash digest (found at the end of the public key file) that is decrypted using the administrator public key. The second hash digest is obtained through hashing the administrator public key using the same hashing algorithm as the one used for the encrypted administrator public key digest (found at the end of the administrator public key). If the integrity of the administrator public key has not been compromised, the resulting hash digests will be identical. If these hash digests are not identical, it indicates that the administrator public key has been altered.

Once integrated in the encryption tool, the administrator public key is used as a master key to recuperate the user's data on the electronic data storage device if the user forgets his opening password.

It is possible, in accordance with some aspects of the present invention, to omit steps 103-109, when the method and encryption tool of the present invention are used only by a user, without involvement of any administrator.

The installing then continues by deleting files on the electronic data storage device to clear up space. It then converts at step 110 the format of the electronic data storage device to New Technology File System (NTFS) if the computer on which the electronic data storage device is connected to has administrator privileges. Other formatting means such as those provided by Windows could alternatively be used as well. If the computer does not have unlimited privileges, the encryption tool will simply delete files it finds on the electronic data storage device without converting the format. The step 110 of converting is not absolutely essential, but desirable as it facilitates subsequent steps of the present method.

The installing continues with step 113 by storing the encryption tool on the electronic data storage device by use of a computer. Step 113 includes, prior to storing the encryption tool on the electronic data storage device, that the installer makes sure to install the encryption tool on an electronic data storage device. And, if the device is not an electronic data storage device, installation of the encryption tool fails. Step 113 also includes verifying, in an event that multiple electronic data storage devices are connected to a computer, which electronic data storage device the encryption tool should be installed onto. The encryption tool could be extracted from a disk, or downloaded from a server on the World Wide Web prior to its installing.

At step 114, the last installing step is to create a file system on the electronic data storage device on which it is installed, and hide all the corresponding modules' folders onto the electronic data storage device. These folders are also converted into system folders to better hide them. When the electronic data storage device is connected to a computer and a user opens a computer browser, only an executable file appears to launch the present method and encryption tool. Since the storage module is hidden, all encrypted user files are located in a hidden folder. The installing is completed and followed by configuring of the encryption tool.

The configuring begins with step 115 of opening the encryption tool through an operating system of the computer. Examples of the operating system include without being limited thereto Windows™, Linux™ Unix™, Mac™, etc.

The method continues the configuring part at step 118 by filling the content of the electronic data storage device with insignificant data. This step increases the security level of electronic data storage device by preventing the user to copy any data directly on the electronic data storage device without first protecting it. Therefore, a user has to open the encryption tool to copy data on the electronic data storage device. The insignificant data may consist of a series or random information, or a series of bit of similar value, or any other combination, which fills the content of the electronic data storage device, and is unintelligible. Alternatively, the insignificant data may be replaced by a change of pointer in the file system stored on the electronic data storage device so as to give the impression that the electronic data storage device is full.

The configuring part continues at step 120 by verifying if it is a first session, and in the affirmative, the user is led to step 122 by indicating an administrator public key received earlier from his IT administrator. It then pursues at step 124 with the entering of a user password. In the event that the steps 103-109 have been omitted as there are no administrator, the method and encryption tool of the present invention simply omit step 122.

The configuring part of the method continues at step 126 with generating of a user public key from the configuring password. So as to increase the security of the electronic data storage device, the user public key is an asymmetric key. An asymmetric key generator, such as the Rivest, Shamir, and Adelman (RSA) public key generator is used to generate the user public-private key pair. Once created, this user public key is hashed with a hashing algorithm such as SHA-1, SHA-256 or MD5. The user public key hash digest is encrypted using the private key from the private-public key pair. The encrypted hash digest is saved at the end of the user public key file. The hashing function is used to ensure that the user public key file integrity has not been compromised.

The integrity verification, performed when there is a password change, is accomplished when the user public key is used to open the encryption tool by comparing two hash digests. The first hash digest comes from the encrypted user public key hash digest (found at the end of the public key file) that is decrypted using the user public key. The second hash digest is obtained through hashing the user public key using the same hashing algorithm as the one used for the encrypted user public key digest. If the integrity of the user public key has not been compromised, the resulting hash digests will be identical. If these hash digests are not identical, the user public key has been altered.

The configuring part continues at step 128 with storing of the administrator and the user public keys on the electronic data storage device. Before storing these public keys, the required volume space is freed on the electronic data storage device. The freeing step may consist for example of deleting a part of the insignificant data equivalent in volume to the public keys to be stored. Afterwards, the public keys are stored on the electronic data storage device. After storing the public keys, the encryption tool finally fills any free space left on the device with insignificant data.

At step 130, the method proceeds with generating a secret key from one or multiple random values. In an aspect of the present invention, the secret key is a symmetric key obtained through a generator of random number. The secret key is used to encrypt data or file(s). Once generated, it is separately protected by use of the user public key and by the use of administrator public key at step 132. Before storing both encrypted secret keys on the electronic data storage device, the required volume space is freed on the electronic data storage device. Afterwards, the encrypted secret keys are stored on the electronic data storage device at step 134. After storing the encrypted secret keys, the encryption tool finally fills any free space left on the device with insignificant data. The configuration part of the method is then completed. In the event that no administrator part is performed, it is clear that steps 122, 128 132 and 134 could be performed alternatively without requiring the administrator public key, and only with the user public key.

When the configuring part of the method is completed, the method pursues with steps of opening a session in order to securely store data on the electronic data storage device. If the opening of the session follows directly the configuration steps, the application will automatically be opened and be ready to use without any user intervention as shown at step 149.

However, if the opening of the session does not directly follow the configuration steps, the user will need to launch the application by either double clicking on the encryption tool executable file using a computer browser and then, enter his/her password to open the encryption tool at step 135. From the entered password, a user private key is generated using the asymmetric key generator at step 137. Once this user private key is generated, step 139 further continues by using this user private key to decrypt the encrypted secret key as shown at step 132. If the secret key is successfully decrypted, the encryption tool opens as per step 149. If the decryption of the secret key fails, the administrator password is needed to open the encryption tool.

The encryption tool can also be opened by entering the administrator password (step 103), combined to the administrator private key file of step 141. An administrator secret key is then generated from the entered opening password at step 135. Step 143 indicates that this secret key is used to decrypt the encrypted administrator private key file originally found on the administrator computer using the symmetric decryption algorithm. If the decryption fails, the encryption tool does not open as per step 147. If the administrator private key is duly decrypted, step 145 continues with decrypting the encrypted secret key shown at step 132 using the administrator private key. If this last decryption fails, the encryption tool does not open as per step 147. If the decryption is successfully accomplished, the encryption tool opens as per step 149.

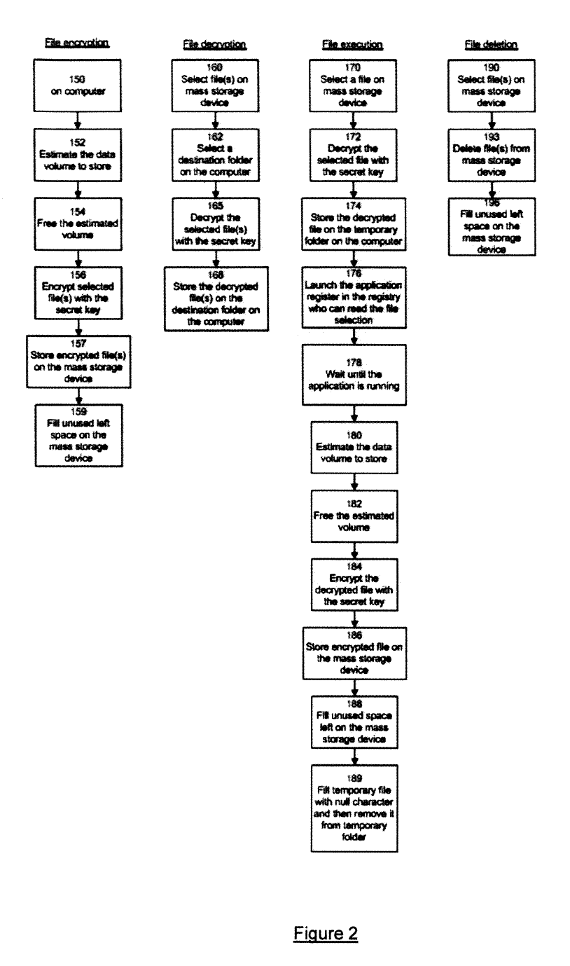

Once opened, the encryption tool continues with securely storing data on the electronic data storage device at step 149. At step 150 (shown on FIG. 2), a file or files are selected by the user for encryption in the section representing the computer on which the electronic data storage device is connected to. The user drags in drops his/her selection in the section of the encryption tool representing the electronic data storage device. Since the electronic data storage device has been filled with insignificant data, it is thus necessary to then first free space on the electronic data storage device, prior to storing new information thereon as per step 154. To ensure that only the required volume of space is freed on the electronic data storage device, the method continues at step 152 by estimating a data volume required after encrypting. To efficiently estimate the data volume after encrypting, the required volume calculation is done by taking the data file size provided by the operating system and increasing it of 10%. To this result is added a minimum kilobyte size (4 Kb in FAT 32, 32 kb in FAT, 64 kb in NTFS) of the file system sector for each selected file.

Once the encrypted data volume has been estimated, the method continues at step 154 with freeing the estimated volume space on the electronic data storage device. The freeing step 154 may consist for example of deleting a part of the insignificant data equivalent in volume to the estimated volume of the information to be stored. Afterwards, the file selection is encrypted at step 156 with the decrypted secret key stored on the electronic data storage device using the symmetric cryptography algorithm. At step 157, the encrypted file selection is stored on the volume freed on the electronic data storage device. Once the encrypted file selection is stored on the electronic data storage device, the encryption tool fills any free space left on the device with insignificant data and updates the file system on the electronic data storage device at step 159.

In order to use the method of the present invention on the electronic data storage device at decryption, the user selects one or multiple files in the section representing the electronic data storage device as per step 160. He/she then drags 'n drops it in the computer section of the encryption tool or directly out of the encryption tool onto his desktop as per step 162. At step 165, once the selection is dropped, the secret key is used to decrypt it using the symmetric cryptography algorithm. The decrypted file selection is copied on the computer as per step 168 while the encrypted files remain secured on the electronic data storage device.

In step 170, in order to use the method of the present invention on the electronic data storage device to consult secured files directly located on the device, the user makes his/her file selection in the encryption tool section representing the electronic data storage device. He/she then double-clicks on his/her selection to launch the decryption process in user temporary folders with the secret key using the symmetric cryptography algorithm (steps 172 and 174). Step 176 automatically executes the appropriate editing software to open the decrypted file selection. Once the editing software is closed as shown in step 178, before the file is automatically re-encrypted, the encryption volume is estimated.

Once the volume has been estimated as per step 180, the method continues at step 182 with freeing the estimated volume space on the electronic data storage device. Afterwards, the file selection is encrypted at step 184 using the decrypted secret key stored on the electronic data storage device. At step 186, the encrypted file selection is stored back on the volume freed on the electronic data storage device. Once the encrypted file selection is stored on the electronic data storage device, the method finally fills any free space left on the device with insignificant data at step 188. Instructions are given to the host computer operating system to keep the temporary files in memory. But if the operating system places the temporary files on the host computer, the temporary files are filled with null characters before being deleted from host computer as shown in step 189.

In order to use the method on the electronic data storage device to delete files, step 190 indicates that the user needs to make the file selection he/she wants to delete. Once the selection is complete, the files are being deleted and freed space is filled back with insignificant data as per step 196, and the file system on the electronic data storage device is updated at step 198.

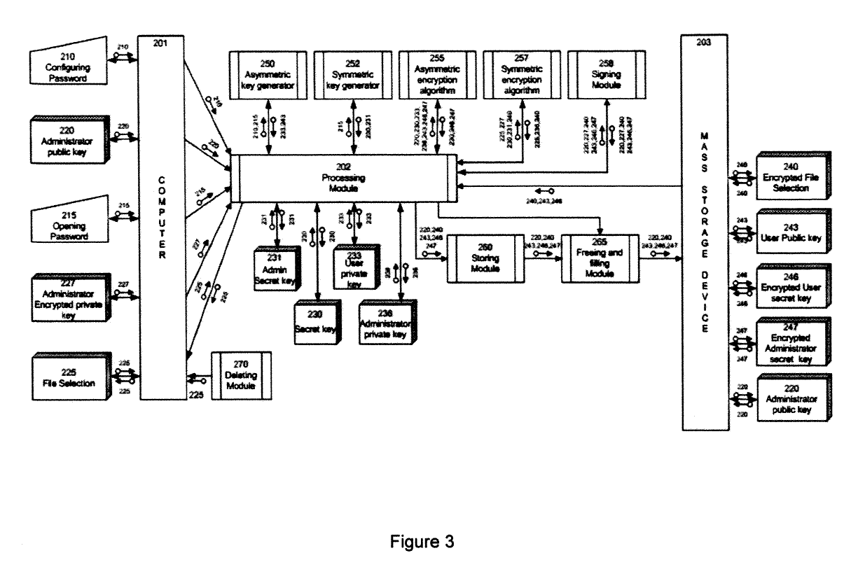

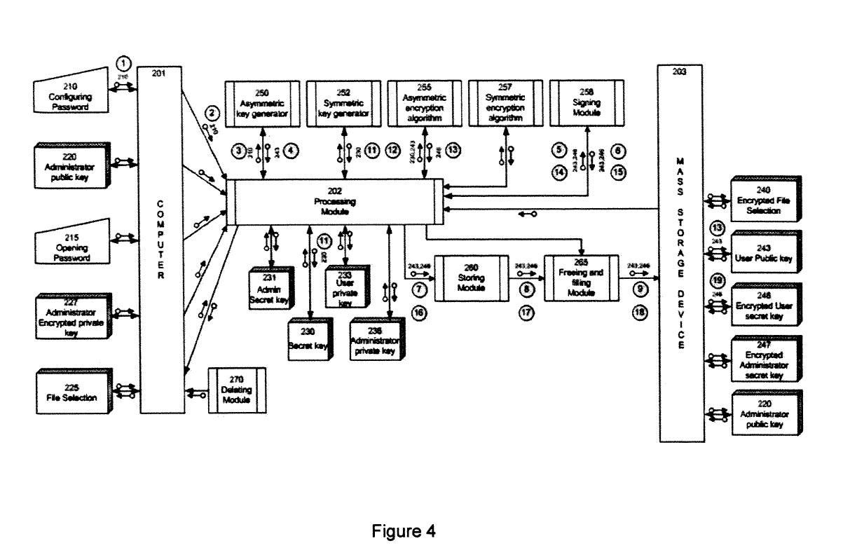

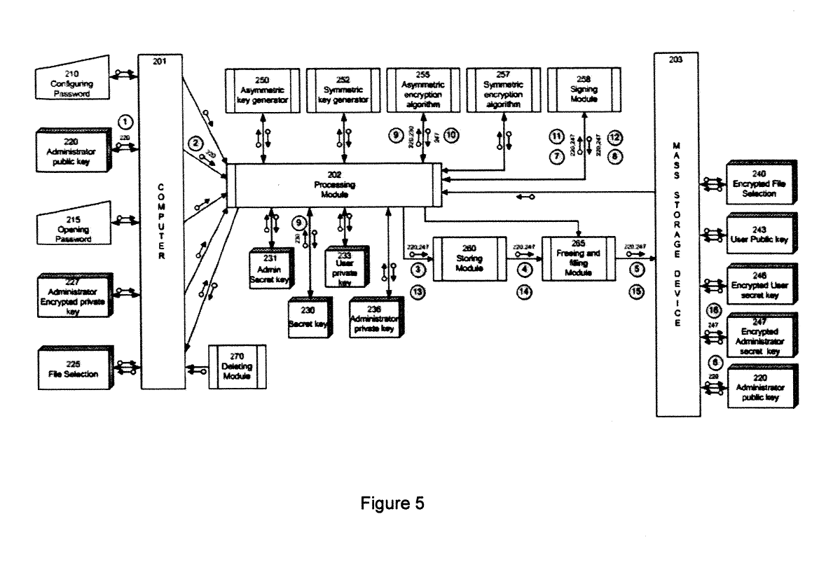

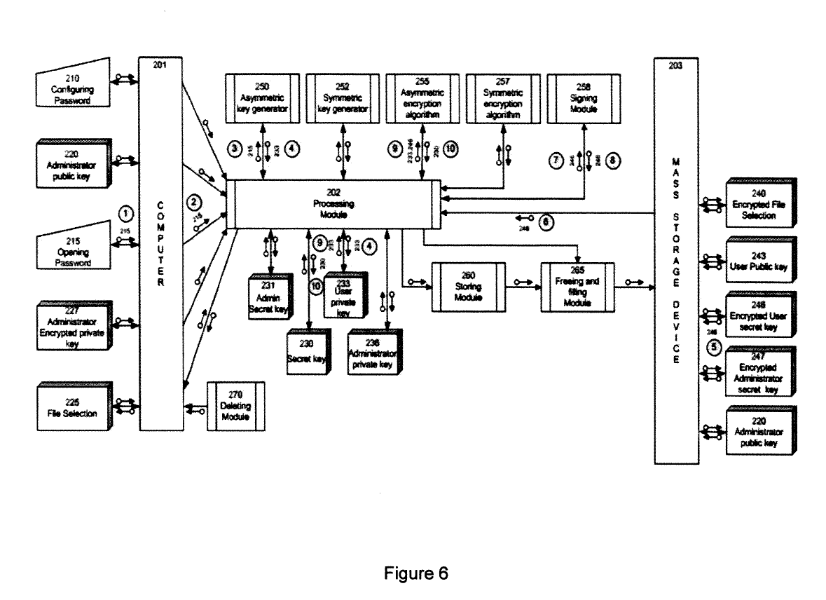

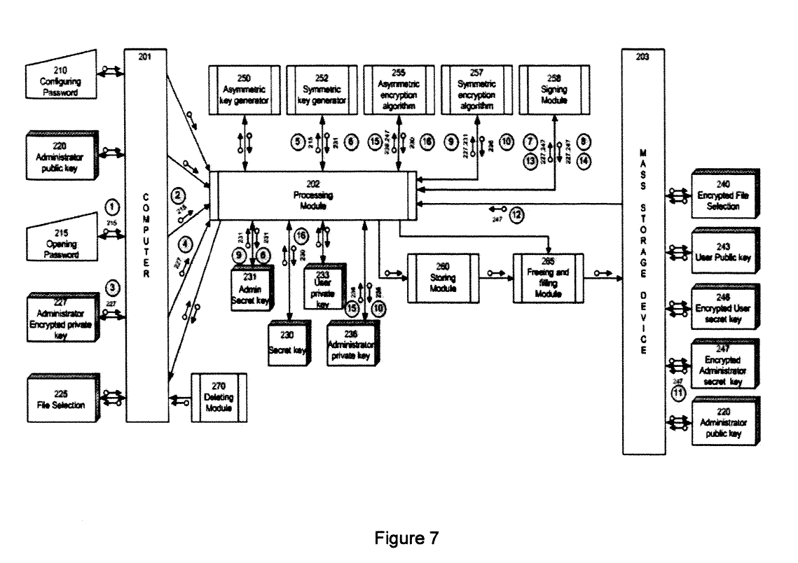

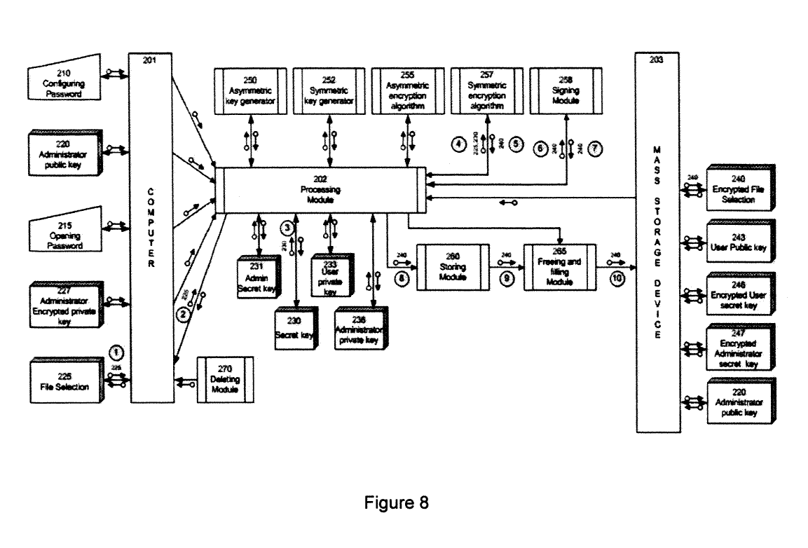

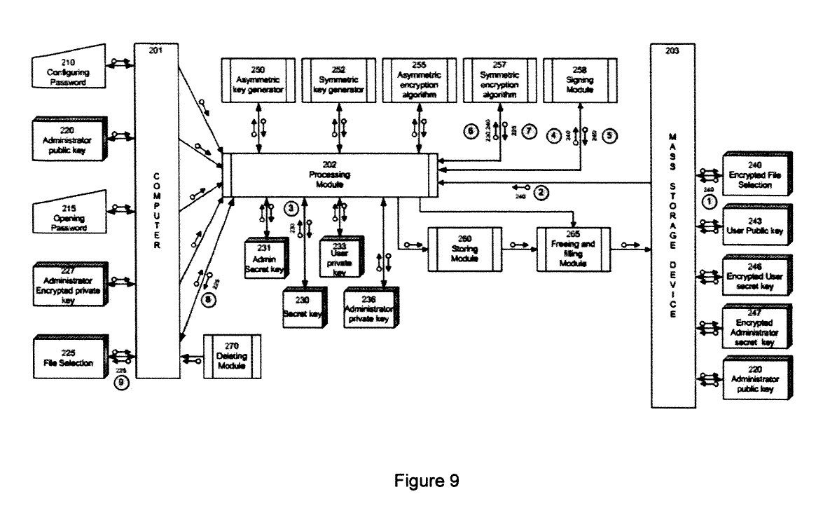

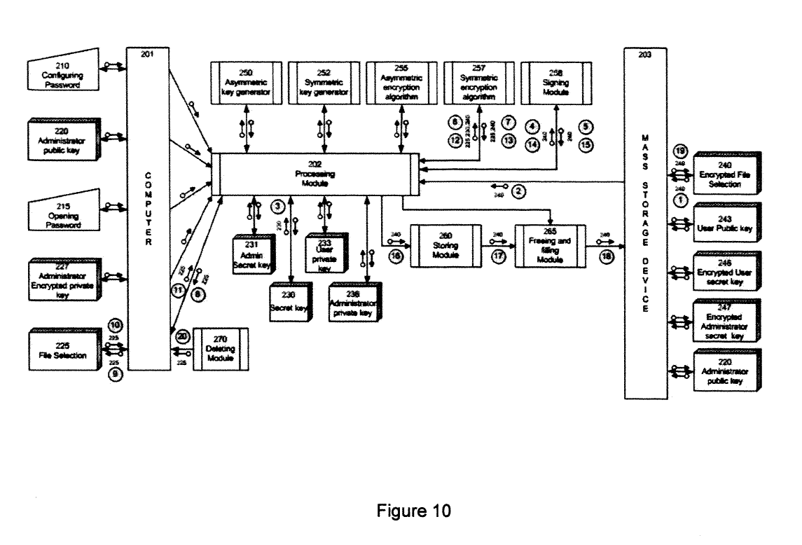

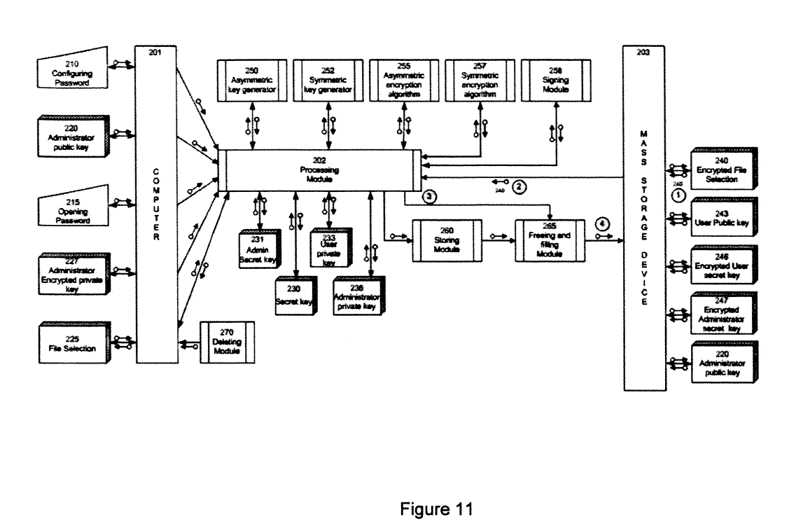

Reference is now made to FIGS. 3-11, which show block diagrams of the encryption tool 200 in accordance with multiple aspects of the present invention. In those aspects of the invention, the encryption tool 200 is shown as electronically connected to a computer 201, and electronically connected to an electronic data storage device 203. The encryption tool 200 includes a processing module 202, a key cryptography unit composed of an asymmetric encryption key generator 250 and a symmetric encryption key generator 252, an encryption module composed of an asymmetric encryption algorithm 255 and a symmetric encryption algorithm 257, a signing module 258, a deleting module 270, a freeing and filling module 265, and a storage module 260. The symmetric encryption key generator 252, the asymmetric encryption key generator 250, the asymmetric encryption algorithm 255, the symmetric encryption algorithm 257, the signing module 258, the deleting module 270, the freeing and filling module 265, the storage module 260 and finally the processing module 202 are modules of software installed on the electronic data storage device. The computer 201 acts as an interface between the encryption tool of the present invention, and users thereof. The processing module 202 further acts as input module for the encryption tool and a random value generator. The freeing and filling module may alternatively be integrated within the storing module, which can also act as a converter if desired.

In an aspect of the present invention, it is the computer 201 that receives the administrator public encryption key 220, the configuring password 210 (step 124), the encrypted administrator private key 227, the file selection 225 and the user password 215 (step 135).

The computer 201 forwards the administrator encryption public key 220, the encrypted administrator private key 227, the configuring password 210, the opening password 215, and the file selection 225 to the processing module 202. The processing module 202 is adapted to determine what to do with inputs received from the computer 201. The electronic data storage device 203 is a hardware component that receives data from the storing module 260 and that also sends data for decryption to the processing module 202. The asymmetrical key generator 250 is conceived to receive the configuration password 210 or the opening password 215, and to generate there from a private-public key pair 233 and 243. The symmetric key generator 252 generates the administrator secret key 231 from the opening password 215. The symmetric key generator 252 also generates the secret key 230 from random values. The asymmetric encryption algorithm 255 receives one key from the private-public key pair (220, 233, 236 and 243) to be used as encryption or decryption key. The asymmetric encryption algorithm 255 can also receive any data to be encrypted or decrypted (236, 246 and 247). The symmetric encryption algorithm 257 receives the secret key 230 or the administrator secret key 231 to be used as encryption or decryption key. The asymmetric encryption algorithm 257 can also receive any data to be encrypted or decrypted (225, 227 and 240).

The signing module 258 is adapted to receive any data and to make a digital fingerprint of such data to ensure its integrity. The storing module 260 and the freeing and filling module 265 are adapted to place the data on the electronic data storage device 203. The storing module 260 estimates the data volume needed to write on the electronic data storage device 203 and also writes on the electronic data storage device 203. The freeing and deleting module 265 frees volume on the electronic data storage device 203 and fills the electronic data storage device 203 after each operation. The deleting module 270 deletes data on the computer by replacing it with null characters. The storage module 260 also updates a file system kept on the electronic mass storage device 203.

The configuring password 210 is used to configure the encryption tool. The computer 201 sends the configuring password 210 to the processing module 202. The processing module 202 then sends this configuring password 210 to the asymmetric key generator 250 which returns a private-public key pair (233-243) back to the processing module 202. The user public key 243 is sent to the storing module 260 which using the freeing and filling module 265 stores the user public key 243 on the electronic data storage device 203. Before being stored, the user public key's 243 integrity can be protected by an appended digital signature using the signing module 258.

With the symmetrical key generator 252, the secret key 230 is generated from random values. This secret key 230 will later be used to encrypt and decrypt data on the electronic data storage device 203. The secret key 230 is encrypted using the asymmetric encryption algorithm 255 with the user public key 243. The asymmetric encryption algorithm 255 returns an encrypted user secret key 246 to be stored on the electronic data storage device 203 using the storing module 260 and the freeing and filling module 265. Before being stored, the encrypted user secret key's 246 integrity can be protected by an appended digital signature using the signing module 258. The private key 233 can be discarded at this point.

The administrator public key 220 is used in conjunction with the configuring password 210 to configure the encryption tool. The computer 201 sends the administrator public key 220 to the processing module 202. The processing module 202 using the storing module 260 and the freeing and filling module 265 will store the administrator public key 220 on the electronic data storage device 203. The secret key 230 is encrypted using the asymmetric encryption algorithm 255 with the administrator public key 220. Before using the administrator public key 220, the administrator public key's 220 integrity is verified by the signing module 258. The asymmetric encryption algorithm 255 returns the encrypted administrator secret key 247 on the electronic data storage device 203 using the storing module 260 and the freeing and filling module 265. Before being stored, the encrypted administrator secret key's 247 integrity can be protected by an appended digital signature using the signing module 258.

To open the encryption tool using the user password 215, the computer 201 sends to the processing module 202 the user password 215. This user password 215 is then sent to the asymmetric key generator 250 to generate a private-public key pair (233 and 243). At this point the public key 243 can be discarded. The encrypted user secret key 246 found on the electronic data storage device 203 is decrypted using the asymmetrical encryption algorithm 255. Before decryption, the encrypted user secret key's 246 integrity is verified by the signing module 258. The decrypted secret key 230 is used to encrypt and decrypt file selection 225.

When the user password 215 fails to decrypt the user secret key 246 as described above, the encryption tool may alternately try to open using the encrypted administrator private key 227. The computer 201 sends the password 215 to the processing module 202. The processing module sends the password 215 to the symmetric key generator 252 to generate the administrator secret key 231. This secret key 231 is used to decrypt the encrypted administrator private key 227 received from the computer 201 with a symmetrical encryption algorithm 257. Before decryption, the encrypted administrator private key's 227 integrity is verified by the signing module 258. The processing module 202 takes the encrypted administrator secret key 247 located on the electronic data storage device 203 and decrypts it with the administrator private key 236 using the asymmetrical encryption algorithm 255. Before decryption, the encrypted administrator secret key's 247 integrity can be verified by the signing module 258. The resulting secret key 230 is then used to encrypt and decrypt file selection 225.

The file selection 225 is sent to the processing module 202 by the computer 201. With the secret key 230, the file selection 225 is encrypted using the symmetric encryption algorithm 257. At encryption, the encrypted file selection's 240 integrity can be protected using the signing module 258 by appending a digital signature. The encrypted file selection 240 is sent to the storing module 260 and the freeing and filling module 265. The storing module 260 and the freeing and filling module 265 then save the encrypted file selection 240 on the electronic data storage device 203 and updates the file system 262 accordingly.

The encrypted file selection 240 is sent to the processing module 202 by the electronic data storage device 203. With the secret key 230, the encrypted file selection 240 is decrypted using the symmetric encryption algorithm 257. Before decryption, the encrypted file selection's 240 integrity is verified by the signing module 258. The decrypted file selection 225 is sent to the computer 201.

To execute a decryption directly from the encryption tool, an encrypted file selection 240 is sent to the processing module 202 by the electronic data storage device 203. The secret key 230 is used to decrypt the encrypted file selection 240 using the symmetric encryption algorithm 257. Before decrypting any encrypted file selection 240, the encrypted file selection's 240 integrity is verified by the signing module 258. The symmetric encryption algorithm sends the decrypted file selection 225 and the processing module 202 sends it back on the computer 201 in a user temporary folder. The processing module 202 launches the file selection 225 editing application. Once the editing application is closed, the processing module 202 automatically re-encrypts the file selection 225 with the secret key 230 using the symmetric key encryption algorithm 257. The encrypted file selection 240 is sent to the storing module 260 as well as the freeing and filling module 265 to be placed back on the mass storage module 203. Before sending the encrypted file selection 240, the encrypted file selection's 240 integrity is protected by an appended digital signature using the signing module 258. Once this is completed, the deleting module 270 fills the file selection 225 in the user temporary folder on the computer 201 with null characters before deleting it.

To delete an encrypted file selection 240, the processing module 202 deletes the encrypted file selection 240 from the electronic data storage device 203. The processing module then communicates with the freeing and filling module 265 to fill any free space found on the electronic data storage device 202 with insignificant data, and to update the file system 262 accordingly.

The present invention has been described by way of preferred embodiment. It should be clear to those skilled in the art that the described preferred embodiments are for exemplary purposes only, and should not be interpreted to limit the scope of the present invention. The method and encryption tool as described in the description of preferred embodiments can be modified without departing from the scope of the present invention. The scope of the present invention should be defined by reference to the appended claims, which clearly delimit the protection sought.

1. A method of securing an electronic data storage device, the method comprising steps of:
creating a file system on the electronic data storage device;
requesting a user password;
generating at least one key from the user password using key cryptography; and
storing the at least one key on the electronic data storage device.

2. The method of securing an electronic data storage device of claim 1, further comprising steps of:
encrypting information to be stored on the electronic data storage device;
storing encrypted information on the electronic data storage device; and
updating the file system with file information on stored encrypted information.

3. The method of securing an electronic data storage device of claim 2, wherein the generating of the at least one key from the password using key cryptography includes:
using asymmetric cryptography to generate from the user password a set of public and private keys;
generating a random value;
using symmetric cryptography to generate from the random value a secret key; and
encrypting the secret key using the public key.

4. The method of securing an electronic data storage device of claim 3, wherein the information to be stored on the electronic data storage device is encrypted using the secret key.

5. The method of securing an electronic data storage device of claim 4, further comprising a step of filling the electronic data storage device with insignificant data.

6. The method of securing an electronic data storage device of claim 1, wherein the electronic data storage device is any of the following: a Universal Serial Bus (USB) key, a camera, a Digital Versatile Disc (DVD) writer, a Compact Disc (CD) writer, an external hard drive, or any external memory means.

7. The method of securing an electronic data storage device of claim 3, wherein the asymmetric cryptography is a Rivest, Shamir, and Adelman public-key encryption algorithm.

8. The method of securing an electronic data storage device of claim 3, wherein the password is a user password, and the method further comprises steps of:
entering an administrator password; and
using the symmetric cryptography to generate an administrator secret key;
generating another random value;
using the asymmetric cryptography to generate an administrator public key and an administrator private key from the other random value;
encrypting the administrator private key with the administrator secret key; and
storing the encrypted administrator private key on the electronic data storage device.

9. The method of securing an electronic data storage device of claim 3, wherein the step of encrypting information to be stored on the electronic data storage device includes steps of:
estimating a volume for the information after encrypting;
freeing the volume on the electronic data storage device;
encrypting the information using the secret key and storing the information encrypted on the electronic data storage device; and
filling the volume with insignificant data.

10. The method of securing an electronic data storage device of claim 9, further comprising a step of:
converting the electronic data storage device to New Technology File System (NTFS) prior to filling the electronic data storage device with insignificant data.

11. The method of securing an electronic data storage device of claim 10, further comprising a step of:
verifying that the electronic data storage device is not a computer, and if the electronic data storage device is the computer, preventing converting to NTFS.

12. An encryption tool for securing an electronic data storage device, the encryption tool comprising:
a file system adapted to be installed on the electronic data storage device;
an input module adapted for receiving a user password;
a key cryptography unit adapted for generating at least one key from a received user password; and
a storage module adapted for storing the at least one key on the electronic data storage device.

13. The encryption tool of claim 12, further comprising:
an encryption module adapted to encrypt information to be stored on the electronic data storage device; and
the storage module is further adapted to store the encrypted information on the electronic data storage device and to update the file system with file information on stored encrypted information.

14. The encryption tool of claim 13, wherein the key cryptography unit comprises an asymmetric key generator and a symmetric key generator.

15. The encryption tool of claim 14, further comprising a random value generator.

16. The encryption tool of claim 15, wherein:
the asymmetric key generator is adapted to generate, from the user password, a set of public and private keys;
the symmetric key generator is adapted to generate, from the random value, a secret key; and
the encryption module is further adapted to encrypt the secret key using the public key.

17. The encryption tool of claim 16, wherein the information to be stored on the electronic data storage device is encrypted using the secret key.

18. The encryption tool of claim 17, further comprising an insignificant data generator adapted to fill the electronic data storage device with insignificant data.

19. The encryption tool of claim 18, wherein the storage module is further adapted to:
estimate a required volume for the information after encrypting; and
freeing the required volume on the electronic data storage device.

20. The encryption tool of claim 19, further comprising:
a New Technology File System (NTFS) converter adapted to convert the electronic data storage device to NTFS prior to filling the electronic data storage device with insignificant data.
